(19) United States
(12) Patent Application Publication
(10) Pub. No.: US 2017/0092451 A1
(43) Pub. Date: Mar. 30, 2017

(54) SWITCH AND ELECTRONIC DEVICE

(71) Applicant: KYOCERA Corporation, Kyoto (JP)

(72) Inventors: Takafumi SATO, Yokohama-shi (JP); Yoshikazu HIRANO, Yokohama-shi (JP)

(73) Assignee: KYOCERA Corporation, Kyoto (JP)

(21) Appl. No.: 15/275,871

(22) Filed: Sep. 26, 2016

(30) Foreign Application Priority Data
Sep. 30, 2015 (JP) 2015-194633
Sep. 30, 2015 (JP) 2015-194634

(51) Int. Cl. H01H 50/64; H01H 50/02

(52) U.S. Cl. CPC H01H 50/64; H01H 50/02

(57) ABSTRACT

A switch including a housing comprising a hole at a predetermined surface, an operating part disposed at the hole and configured to move with respect to the predetermined surface, a magnetic body configured to move in conjunction with the operating part, a magnetic sensor disposed in the housing and configured to detect magnetic force by the magnetic body, and a sheet disposed between the magnetic body and the operating part.

### CROSS-REFERENCE TO RELATED APPLICATIONS

This application claims priority to and the benefit of Japanese Patent Application Nos. 2015-194633 filed on Sep. 30, 2015 and 2015-194634 filed on Sep. 30, 2015, the entire contents of which are incorporated herein by reference.

### TECHNICAL FIELD

This disclosure relates to a switch and an electronic device.

### BACKGROUND

A mobile electronic device that employs a slide switch has been conventionally known. For example, a mobile electronic device provided with a switch that is operated by sliding a member along the surface of a housing has been known.

### SUMMARY

A switch according to one embodiment of this disclosure includes a housing that comprises a hole at a predetermined surface, an operating part disposed in the hole and configured to move within the hole, a first ferromagnet configured to move in conjunction with the operating part, one or more magnetic sensors disposed in the housing and configured to detect magnetic force by the first ferromagnet, and a sheet disposed between the first ferromagnet and the operating part. Moreover, an electronic device according to one embodiment of this disclosure includes a housing that comprises a predetermined surface, an operating part disposed at the predetermined surface and configured to move a predetermined distance along the predetermined surface, a ferromagnet configured to move in conjunction with the operating part, a plurality of magnetic sensors disposed in the housing along a movement path of the operating part and configured to detect magnetic force by the ferromagnet, and a controller configured to control switching between predetermined functions. In this electronic device, the controller controls switching between the predetermined functions based on detection results by the plurality of magnetic sensors.

### BRIEF DESCRIPTION OF THE DRAWINGS

In the accompanying drawings:

FIG. 1 is a diagram illustrating an appearance of an electronic device according to one embodiment of this disclosure;

FIG. 2 is a cross-sectional diagram illustrating a configuration of a switch of the electronic device according to the embodiment of this disclosure;

FIG. 3A is a schematic diagram illustrating disposition of a magnetic sensor and a ferromagnet;

FIG. 3B is a diagram illustrating an example of magnetic force detected by the magnetic sensor; and

FIG. 4 is a functional block diagram of the electronic device according to one embodiment of this disclosure.

### DETAILED DESCRIPTION

One embodiment of this disclosure is described below.

The conventionally known mobile electronic device may have no waterproof/dustproof function at its switch. Furthermore, in the conventionally known mobile electronic device, a switch may grow in size. It would therefore be helpful to provide a switch and an electronic device with improved performance.

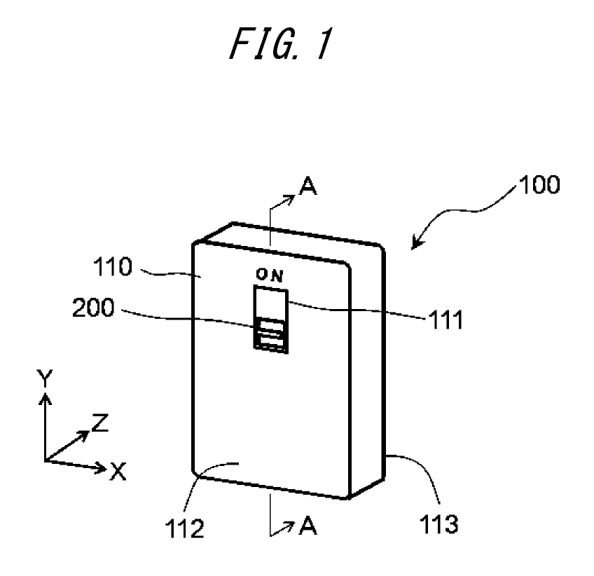

FIG. 1 is a diagram illustrating an appearance of an electronic device 100 according to one embodiment of this disclosure. The electronic device 100 according to one embodiment includes a housing 110 and a switch 200. The housing 110 comprises a back surface 113 facing the Z-axis positive direction and a front surface 112 facing the Z-axis negative direction. The front surface 112 of the housing 110 is provided with a hole 111. The switch 200 is incorporated in the hole 111. The switch 200 switches between predetermined functions of the electronic device 100. In one embodiment, the switch 200 may have a function of switching between ON/OFF of a power supply of the electronic device 100.

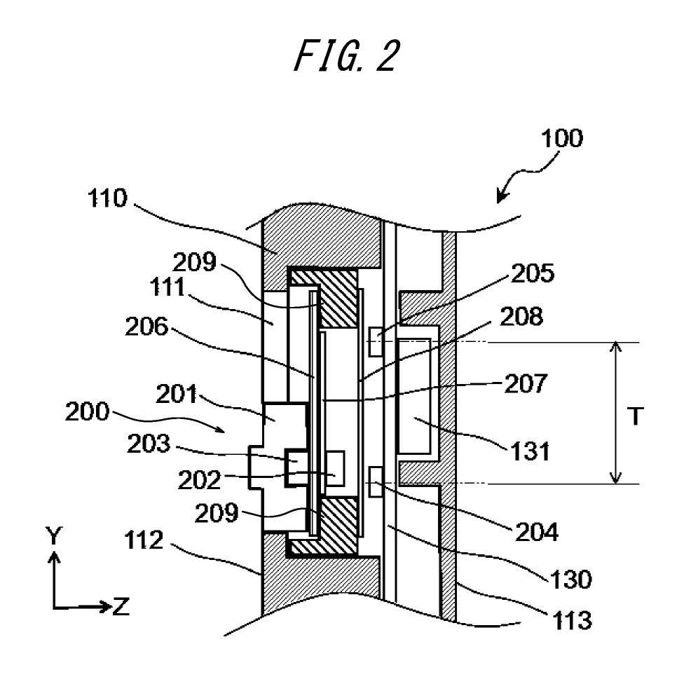

FIG. 2 is a cross-sectional diagram illustrating a configuration of the switch 200 according to one embodiment. FIG. 2 is a cross-sectional diagram viewed along A-A line illustrated in FIG. 1, and mainly illustrates a cross-sectional configuration of the switch 200. The switch 200 includes an operating part 201, a first ferromagnet 202, a second ferromagnet 203, a first magnetic sensor 204, a second magnetic sensor 205 and a sheet 206. The first magnetic sensor 204 and the second magnetic sensor 205 are mounted on the circuit board 130. A circuit component 131 that includes a controller that controls the first magnetic sensor 204 and the second magnetic sensor 205 is mounted on the circuit board 130.

The operating part 201 is disposed in the hole 111 of the housing 110 and moves in the hole 111 along the front surface 112 of the housing 110. In one embodiment, the operating part 201 moves in the Y-axis direction in the hole 111. The movement direction of the operating part 201 is not limited to this. The operating part 201 may move in the X-axis direction along the front surface 112 of the housing 110. The operating part 201 may move in the direction (Z-axis direction) perpendicular to the front surface 112 of the housing 110. For the operating part 201, a portion thereof projects onto the side of the front surface 112. The user operates the operating part 201 that projects from the front surface 112 to switch between the functions of the electronic device 100. The operating part 201 includes the second ferromagnet 203. The second ferromagnet 203 moves in conjunction with the operating part 201. The second ferromagnet 203 and the first ferromagnet 202 are attracted to each other by the magnetic force. Thus, the first ferromagnet 202 moves in conjunction with the second ferromagnet 203. That is, the second ferromagnet 203 moves in conjunction with the operating part 201. Thus, the first ferromagnet 202 moves in conjunction with the operating part 201.

The ferromagnet is a material with properties of being attracted by a magnet. The first ferromagnet 202 and the second ferromagnet 203 may be configured by a magnet. As a magnet, a permanent magnet and an electromagnet may be used. If a compact permanent magnet with strong magnetic force is used, the switch 200 can be reduced in size. A permanent magnet can comprise materials such as, for example, a samarium-cobalt magnet, a neodymium magnet, a ferrite magnet, an Al—Ni—Co magnet or the like. Among the illustrated materials, a neodymium magnet has the strongest magnetic force, thus the switch 200 can be reduced in size. At least one of the first ferromagnet 202 and the second ferromagnet 203 may comprise a soft magnetic material. The soft magnetic material is a material that has a small coercive force and a high magnetic permeability, and may comprise, for example, iron, nickel-iron alloy, martensitic stainless, ferritic stainless, austenitic-ferritic stainless or the like. The material used for the first ferromagnet 202 and the second ferromagnet 203 should have a magnetic force that is strong enough even if the sheet 206 is disposed therebetween.

For example, as the first ferromagnet 202 and the second ferromagnet 203, a neodymium magnet, which is a permanent magnet, may be used. For example, as the first ferromagnet 202, a neodymium magnet, which is a permanent magnet, may be used. For example, as the second ferromagnet 203, a nickel-iron alloy, which is a soft magnetic material, may be used. For example, as the first ferromagnet 202, a nickel-iron alloy, which is a soft magnetic material, may be used. For example, as the second ferromagnet 203, a neodymium magnet, which is a permanent magnet, may be used.

The sheet 206 is disposed between the first ferromagnet 202 and the second ferromagnet 203. The sheet 206 comprises a waterproof or dustproof material. The periphery of the sheet 206 is attached to a step 209 of the hole 111 to prevent water or dust from entering into the housing 110. The first ferromagnet 202 moves in conjunction with the movement of the operating part 201 while being in contact with the surface of the sheet 206. Thus, the sheet 206 employs a material not attracted by a magnet. The sheet 206 does not employ a ferromagnetic material, and employs a material that does not get sticky or melt due to heat. The sheet 206 may comprise a material such as, for example, polyester resin, acrylic resin, glass sheet, aluminum sheet, cloth, or the like. In order not to decrease the magnetic force to attract the first ferromagnet 202 and the second ferromagnet 203 each other, the sheet 206 may be as thin as possible. For example, the sheet 206 may be a polyethylene terephthalate resin. Its thickness may be 0.5 mm or less.

The surface of the sheet 206 to be in contact with the first ferromagnet 202 may be treated with a surface treatment for reducing the coefficient of friction to allow the first ferromagnet 202 to move smoothly on the surface of the sheet 206 in conjunction with the operating part 201. In one embodiment, a fluororesin sheet 207 is attached to a part of the surface on the opposite side of the hole 111 of the sheet 206. As the fluororesin sheet 207, a material such as, for example, Teflon®, Fluon® or the like may be used. The treatment for reducing the coefficient of friction can be, for example, attachment of a nylon resin sheet. The treatment for reducing the coefficient of friction can be, for example, a surface polishing.

The switch 200 may include a drop-prevention sheet 208 between the first ferromagnet 202 and the first magnetic sensor 204 and the second magnetic sensor 205. The drop-prevention sheet 208 can prevent the first ferromagnet 202 from moving to the back surface 113 side of the drop-prevention sheet 208 when the first ferromagnet 202 drops from the surface of the sheet 206 due to impact or vibration. Therefore, even if the first ferromagnet 202 drops from the surface of the sheet 206, it can return to the surface of the sheet 206 due to the magnetic force between it and the second ferromagnet 203. The drop-prevention sheet 208 may be a material that does not reduce the magnetic force of the first ferromagnet 202. The drop-prevention sheet 208 may be a polyester resin sheet or the like, for example.

According to one embodiment, a compact switch with waterproof and dustproof functions can be realized. Furthermore, the switch 200 according to one embodiment has a configuration in which the first ferromagnet 202 that moves in conjunction with the operating part 201 approaches the first magnetic sensor 204 and the second magnetic sensor 205, thus switch sensitivity is improved and switch operation is stabilized. Furthermore, according to the switch 200 of one embodiment, the first ferromagnet 202 can be prevented from being deteriorated by moisture. When a hall element is used as the first magnetic sensor 204 and the second magnetic sensor 205, further reduction in size and further energy saving of the electronic device 100 can be realized.

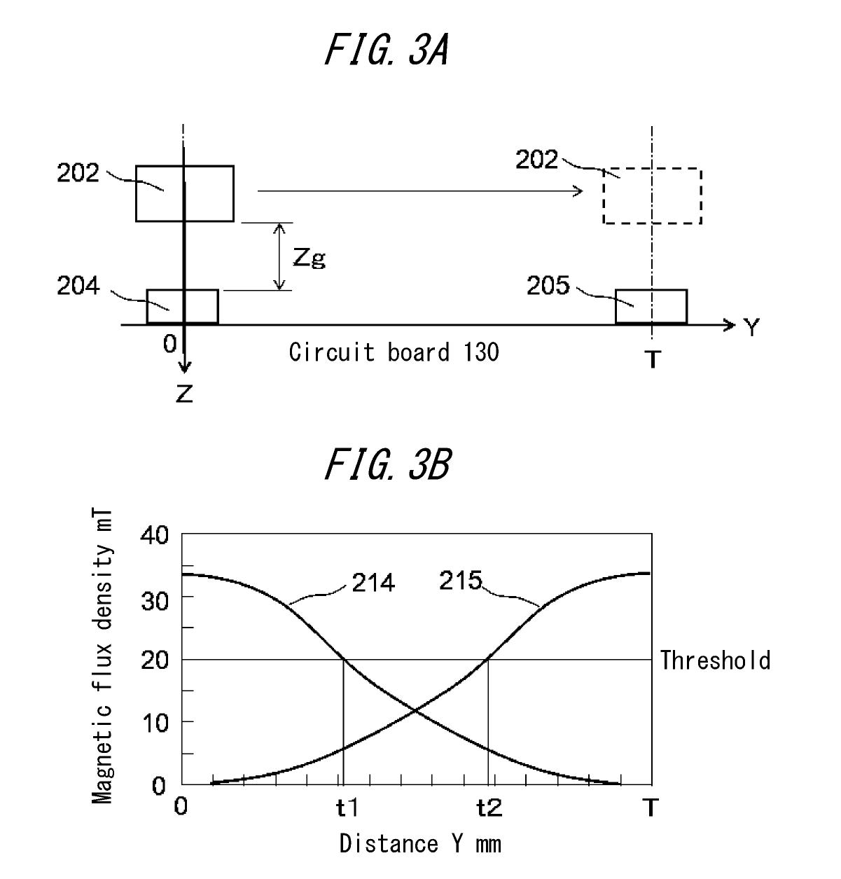

The first magnetic sensor 204 and the second magnetic sensor 205 are a sensor that detects a magnetic force. The first magnetic sensor 204 and the second magnetic sensor 205 are mounted on the circuit board 130 at a predetermined interval, T. The first magnetic sensor 204 and the second magnetic sensor 205 are disposed along a moving path (movement direction) of the operating part 201, and in one embodiment, they are disposed along the Y-axis direction. The first magnetic sensor 204 and the second magnetic sensor 205 can comprise a material such as, for example, a hall element, a magnetic impedance element, a coil or the like. The first magnetic sensor 204 and the second magnetic sensor 205 detect magnetic force when the operating part 201 moves. Both the first magnetic sensor 204 and the second magnetic sensor 205 are not necessarily required. The switch 200 may comprise only the first magnetic sensor 204. Next, operation of the switch 200 that comprises the first magnetic sensor 204 and the second magnetic sensor 205 is described with reference to FIGS. 3A and 3B.

FIG. 3A is a schematic diagram illustrating disposition of the magnetic sensors and the ferromagnets. FIG. 3B is a diagram illustrating one example of magnetic force detected by the magnetic sensor. FIG. 3B is a diagram illustrating magnetic flux density detected by the first magnetic sensor 204 and the second magnetic sensor 205 in a disposition illustrated in FIG. 3A.

FIG. 3A illustrates the first magnetic sensor 204, the second magnetic sensor 205 and the first ferromagnet 202 extracted from the cross-sectional configuration of the switch 200 illustrated in FIG. 2. The first magnetic sensor 204 and the second magnetic sensor 205 are disposed at the circuit board 130 at a predetermined interval, T. Here, the Y-axis is a line connecting the first magnetic sensor 204 and the second magnetic sensor 205, and is included in the mounting surface of the circuit board 130. Provided that the central position of the first magnetic sensor 204 is Y=0, the central axis of the second magnetic sensor 205 is disposed at the position of Y=T. The first ferromagnet 202 indicated by a solid line is disposed so that the central axis of the first magnetic sensor 204 and the central axis of the first ferromagnet 202 are aligned. The first ferromagnet 202 and the first magnetic sensor 204 indicated by a solid line have an interval of gap amount, Zg. From this state, the first ferromagnet 202 moves in the Y-axis positive direction while holding the gap amount, Zg, in the Z-axis direction. The first ferromagnet 202 moves in conjunction with the operation of the operating part 201 by the user. The first ferromagnet 202 moves along the Y-axis to right above the second magnetic sensor 205. The first ferromagnet 202 after its move is indicated by a dotted line. The central axis of the first ferromagnet 202 after its move is aligned with the central axis of the second magnetic sensor 205 and is positioned on the position of Y=T.

FIG. 3B illustrates the detection amount of magnetic flux density detected by the first magnetic sensor 204 and the detection amount of magnetic flux density detected by the second magnetic sensor 205 when the first ferromagnet 202 moves from Y=0 to Y=T. The detection result by the first magnetic sensor 204 is indicated by the line 214. The detection result by the second magnetic sensor 205 is indicated by the line 215. The diagram in FIG. 3B illustrates a detection result when the first ferromagnet 202 is a neodymium magnet with φ2×1 mm, as an example. The diagram in FIG. 3B illustrates a detection result when the gap amount, Zg, is 1.2 mm, as an example. Furthermore, the diagram in FIG. 3B illustrates a detection result when the predetermined interval, T, between the first magnetic sensor 204 and the second magnetic sensor 205 is 8 mm, as an example. The detection amount of the first magnetic sensor 204 is the largest when the position of the first ferromagnet 202 is Y=0. For the first magnetic sensor 204, its detection amount decreases as the first ferromagnet 202 moves in the Y-axis positive direction, and is almost 0 at the position of Y=T. For the second magnetic sensor 205, its detection amount is almost 0 when the position of the first ferromagnet 202 is Y=0. For the second magnetic sensor 205, the detection amount increases as the first ferromagnet 202 moves in the Y-axis positive direction, and the detection amount is the largest at the position of Y=T.

Next, switching of a switch in a controller 300 is described. The controller 300 controls switching between predetermined functions based on each detection result by the first magnetic sensor 204 and the second magnetic sensor 205. In one embodiment, the controller 300 controls the function of switching between power ON and OFF of the electronic device 100. The controller 300 controls switching function by comparing the preset threshold with each detection result by the first magnetic sensor 204 and the second magnetic sensor 205. The controller 300 determines whether or not the detection result of each of the first magnetic sensor 204 and the second magnetic sensor 205 is the predetermined threshold or more.

For example, as illustrated in FIG. 3B, the case where the predetermined threshold is the magnetic flux density of 20 mT is described. In the case of the position of the operating part 201 illustrated in FIGS. 1 and 2, the first ferromagnet 202 is disposed at the position of Y=0˜t1. Thus the detection result by the first magnetic sensor 204 is the threshold or more. On the other hand, the detection result by the second magnetic sensor 205 is less than the threshold. In this state, the power supply of the electronic device 100 is in an OFF state. When the operating part 201 is operated to move along the Y-axis, the first ferromagnet 202 is disposed at the position of Y=t1˜t2. Here, the detection results of both the first magnetic sensor 204 and the second magnetic sensor 205 are respectively less than the threshold. In this case, the controller 300 keeps the last state. More specifically, the controller 300 leaves the power of the electronic device 100 in an OFF state. When the operating part 201 is operated to move further along the Y-axis, the first ferromagnet 202 is disposed at the position of Y=t2˜T. The detection result by the first magnetic sensor 204 is less than the threshold. On the other hand, the detection result by the second magnetic sensor 205 is the threshold or more. In this state, the controller 300 executes switching between switch functions. More specifically, the controller 300 switches the power of the electronic device 100 from OFF to ON. When the threshold is set to a value that does not allow the detection results by a plurality of magnetic sensors to become the threshold or more simultaneously, the switching operation is stabilized and the electronic device 100 operates stably. However, control based on a threshold is not limited to it. If the threshold is set low, a region where the detection results by two magnetic sensors simultaneously become the threshold or more is generated. However, if the controller 300 keeps the last state, switching function can be realized without causing a malfunction. When a magnet approaches the electronic device 100, the detection results of the first magnetic sensor 204 and the second magnetic sensor 205 may become the threshold or more simultaneously. On that occasion, the controller 300 keeps the last state, and as a result of this, a malfunction due to external magnetic field can also be prevented. Thus, the electronic device 100 can realize a stabilized operation. In this case, a magnetic shield is not needed any more in the electronic device 100, thus reduction in size of the electronic device 100 is realized. In one embodiment, when the number of magnetic sensors whose detection result exceeds the threshold is 1, the controller 300 switches between functions based on the position of the magnetic sensor whose detection result exceeds the threshold. Furthermore, when the number of the magnetic sensors whose detection result exceeds the threshold is 2 or 0, the controller 300 keeps the last function.

In one embodiment, although an example where the number of magnetic sensors is 2 is described, the number of magnetic sensors is not limited to this. For example, when the number of magnetic sensors is 1, the controller 300 may switch between functions of the electronic device 100 based on whether or not the detection result is the preset threshold ore more. At the time, a magnetic shield may be applied to around the magnetic sensor or to the housing 110 so as not to cause the operation of the electronic device 100 to be unstable due to external magnetic field. For example, the number of magnetic sensors may be 3 or more. In that case, the controller 300 can control switching among 3 or more functions.

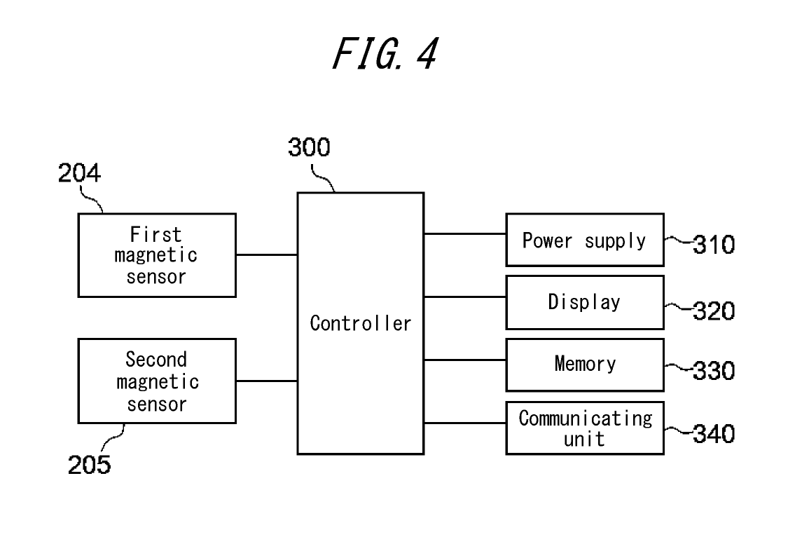

FIG. 4 is a diagram illustrating a function block diagram of the electronic device according to one embodiment. The electronic device 100 includes the first magnetic sensor 204, the second magnetic sensor 205, the controller 300, a power supply 310, a display 320, a memory 330 and a communicating unit 340. In one embodiment, the first magnetic sensor 204, the second magnetic sensor 205, the controller 300, the power supply 310, the memory 330 and the communicating unit 340 may be configured by being incorporated respectively in the electronic device 100. Furthermore, in one embodiment, the display 320 may be provided on the front surface 112 and the back surface 113 of the electronic device 100.

As described above, the first magnetic sensor 204 and the second magnetic sensor 205 detect respectively magnetic force of the ferromagnet moving in conjunction with the operating part 201. In one embodiment, the electronic device 100 may include 3 or more magnetic sensors.

The controller 300 is a processor that controls and manages whole electronic device 100 including each functional block of the electronic device 100. The controller 300 compares each detection result detected by a plurality of magnetic sensors with the preset threshold. After comparing each detection result with the threshold, the controller 300 controls switching between functions of the electronic device 100 based on the number and the position of the magnetic sensors whose detected detection result is the threshold or more. For example, the controller 300 may control ON/OFF of a power supply, a display apparatus and a communicating function, and switching between display states, communication modes or the like. The controller 300 is configured by a processor such as a CPU (Central Processing Unit) or the like that executes a program that specifies control procedures and a program that determines switching between functions. Such program may be stored in a storage medium such as, for example, the memory 330 or the like.

The power supply 310 includes, for example, a lithium ion battery and a control circuit for its charge and discharge or the like. The power supply 310 supplies power especially to a magnetic sensor (the first magnetic sensor 204 and the second magnetic sensor 205) including the whole electronic device 100.

The display 320 is a display device such as a liquid crystal display, an organic EL (electro-luminescence) display or an inorganic EL display or the like. The display 320 may perform a predetermined display when the user operates the switch 200.

The memory 330 can be configured by a semiconductor memory, a magnetic memory or the like, stores various kinds of information and a program or the like for operating the electronic device 100 and functions as a work memory. The memory 330 may store the detection results by the first magnetic sensor 204 and the second magnetic sensor 205, for example.

The communicating unit 340 transmits and receives various kinds of data via wired or wireless communication with an external apparatus. The communicating unit 340 may communicate with an external apparatus, for example, and transmit the results detected by the electronic device 100 to the external apparatus.

According to one embodiment of this disclosure, a switch and an electronic device that allow improvement of performance can be provided.

Although this disclosure has been described based on various drawings and examples, it is to be noted that various changes and modifications will be apparent for those skilled in the art based on this disclosure. Therefore, such changes and modifications are to be understood as included within the scope of this disclosure. For example, the functions or the like included in each means, each member or the like may be reordered in any logically consistent way. Furthermore, a plurality of means, members or the like may be combined into one or divided.

1. A switch, comprising:
a housing comprising a hole at a predetermined surface;
an operating part disposed in the hole and configured to move within the hole;
a first ferromagnet configured to move in conjunction with the operating part;
one or more magnetic sensors disposed in the housing and configured to detect magnetic force by the first ferromagnet; and
a sheet disposed between the first ferromagnet and the operating part.

2. The switch according to claim 1, wherein the operating part is configured to move in the direction parallel to the predetermined surface.

3. The switch according to claim 1, wherein the operating part comprises a second ferromagnet, and the first ferromagnet moves in conjunction with the operating part by magnetic force generated between the first ferromagnet and the second ferromagnet.

4. The switch according to claim 3, wherein at least one of the first ferromagnet and the second ferromagnet is configured by a permanent magnet.

5. The switch according to claim 3, wherein at least one of the first ferromagnet and the second ferromagnet is configured by a soft magnetic material.

6. The switch according to claim 1, wherein the sheet comprises a waterproof or a dustproof property.

7. The switch according to claim 1, wherein a surface being in contact with the first ferromagnet on the sheet comprises fluororesin.

8. The switch according to claim 1, wherein the one or more magnetic sensors comprise a hall element.

9. The switch according to claim 1, wherein a plurality of the one or more magnetic sensors are disposed in the housing along the direction in which the operating part moves.

10. An electronic device, comprising
a switch according to claim 1; and
a controller configured to control switching between predetermined functions, wherein
the controller controls switching between the predetermined functions based on a comparison between a detection result detected by the one or more magnetic sensors and a predetermined threshold.

11. An electronic device, comprising:
a housing comprising a predetermined surface;
an operating part disposed at the predetermined surface and configured to move a predetermined distance along the predetermined surface;
a ferromagnet configured to move in conjunction with the operating part;
a plurality of magnetic sensors disposed in the housing along a movement path of the operating part and configured to detect magnetic force by the ferromagnet; and
a controller configured to control switching between predetermined functions, wherein
the controller controls switching between the predetermined functions based on a detection result by the plurality of magnetic sensors.

12. The electronic device according to claim 11, wherein the controller compares the detection result detected by the plurality of magnetic sensors with a predetermined threshold and controls switching between the predetermined functions based on a number and a position of a magnetic sensor by which a detection result that is the predetermined threshold or more is detected.

13. The electronic device according to claim 12, wherein the plurality of magnetic sensors are disposed at intervals by which each detection result by magnetic sensors adjacent to each other does not simultaneously exceed the predetermined threshold while the operating part moves a predetermined distance.

14. The electronic device according to claim 12, wherein the controller does not execute switching between the predetermined functions when two or more detection results, each being the predetermined threshold or more, are detected simultaneously.

15. The electronic device according to claim 12, comprising:
two of the plurality of magnetic sensors, wherein the controller executes ON/OFF of power supply of the electronic device based on determination on from which of the magnetic sensors a detection result exceeding the predetermined threshold is detected.

16. The electronic device according to claim 11, wherein the plurality of magnetic sensors comprise a hall element.
